(19) United States
(12) Patent Application Publication
(10) Pub. No.: US 2008/0105104 A1
(43) Pub. Date: May 8, 2008

(54) SLOTTED PERCUSSION INSTRUMENTS

(76) Inventor: JOHN STANNARD, CLEARWATER, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/925,810

(22) Filed: Oct. 27, 2007

Related U.S. Application Data
(60) Provisional application No. 60/856,955, filed on Nov. 6, 2006.

(51) Int. Cl. G10D 13/08

(52) U.S. Cl. 84/402

(57) ABSTRACT

A metal percussion instrument, which includes a cymbal that is formed with open or closed slots or grooves. In one embodiment, the invention can have formed cantilevers or internally formed cantilevers. Typically, the main vibrating section is composed of a metal alloy of a specific gravity greater than 6. Weights may be added to desired locations on the instrument. These weights may be pieces of metal including bells, domes, and other vibrating metal shapes. The instrument is configured so that one or more slots are located to create multiple modes of vibration which affect an entire frequency response of the instrument and create one or more fundamental frequencies with a greater number of audible overtones thereby building a complex overall sound.

### RELATED APPLICATION

This application claims the benefit of U.S. Provisional Patent Application 60/856,955 filed Nov. 6, 2006.

### FIELD OF THE INVENTION

The invention relates to percussion instruments, in particular to slotted percussion instruments.

### BACKGROUND OF THE INVENTION

By way of background to further understand the invention described hereinafter, the following definitions are provided.

Slot: An aperture or groove in an area of material which proceeds either completely through the entire cross-section or consists of a valley, furrow, or channel in the material along a curved or straight line. Slots or grooves can be of continuous or varying width. Grooves can be of continuous or varying depth. Slots can be created by means of material removal such as cutting, lathing, abrading, milling, skiving, scraping, chemical etching, or laser etching. Ridges and valleys which resemble grooves can also be created by plating, welding and other methods which add material to the surface of the instrument. FIG. 1 provides conceptual depictions of examples of slot and/or groove types typical of the invention described below.

Open slot: Defined herein as a slot, which begins at a point on the plane of the instrument and proceeds outwards till the slot reaches the edge of the instrument.

Closed slot: Defined herein as a slot, which begins at a point on the plane of the instrument and proceeds outward but terminates before reaching the edge of the instrument. Closed slots can also be created by first creating open slots then welding the material closed at one or more points. Closed slots can be shaped in a manner which forms a cantilever within the instrument.

Groove: Defined as a valley or furrow or channel along a curved or straight path. Grooves as defined here do not sever the cross section of the material. Grooves can be of varying length, width, and depth. Ridges and valleys which resemble grooves can also be created by plating, welding and other methods which add material to the surface of the instrument. Grooves can be created by means of material removal such as cutting, lathing, abrading, milling, skiving, scraping, chemical etching, or laser etching.

Bronze: As defined herein shall comprise any metal in which copper is alloyed with other elements to alter its properties. Such alloys include but are not limited to: phosphor/tin bronzes, high tin bronzes known as “bell” bronze, nickel bronze, aluminum bronze, titanium bronze, beryllium copper, nickel silver (a copper/zinc/nickel alloy), brass (brass is sometimes referred to as a type of bronze, and it shall be included in the bronze class herein) and combinations of these bronze alloys.

Overtones: Overtones can be heard as simpler or individual tones or frequencies, which when combined make up the whole of a musical sound. The sum of simple sounds such as sine waves, rising and falling in amplitude and frequency can produce a complex sound. In percussion instruments, there is a complex matrix of overtones comprising the whole.

Swell: A term in music and in describing cymbal and gong sound whereby sound grows in time from low to high amplitude. In cymbals, gongs and hybrid instruments, a rise in the frequency and complexity or number of overtones also accompanies the rise in amplitude.

Hybrid Instrument: An instrument which, due to specific forming techniques, shapes, and materials, is suspended in ways similar to a gong while producing sounds similar to both cymbals and gongs.

Attack: The sound heard immediate after the striking of a percussion instrument. The attack is also defined as the amount of time it takes for the sound of a percussion instrument to reach full volume or amplitude after a single strike. An instrument with a large amount of swell (such as a large gong struck with a soft mallet) would have a slow attack. An instrument such as a bell struck with a metal clapper or a triangle would have a fast attack.

Hum note or Fundamental Tone: In percussion instruments, such as large bells, cymbals, and gongs, as well as hybrid instruments, there exists a low frequency sound which is, depending on the instrument, loud or soft in amplitude. In cymbals, this note is much lower in frequency than the accompanying overtones. Instruments with a low frequency hum note or fundamental tone can produce a greater complexity of high frequency overtones. For example, a small, rigid bell with a fundamental tone of 500 cycles per second will have a small number of audible overtones which ring at increasingly high frequencies. A large cymbal or gong, formed in a flexible shape, with a fundamental or hum note in the 50 cycle range will produce an extremely complex series of overtones.

Bow: The curve or radius of the main body of a cymbal, gong, or hybrid instrument.

### SUMMARY OF THE INVENTION

This invention comprises metal percussion instruments such as cymbals, gongs, and hybrid percussion instruments which feature slots created in the instrument, and/or cantilevers welded to the instrument to affect a result similar to said slots. The slots serve to create sections of metal which vibrate differently than instruments without slots. Such slots can lower the rigidity of one or more areas of the instrument, hence creates lower fundamental tones.

By lowering the frequency of the fundamental tone and/or forming multiple fundamental tones, a greater number of modes of vibration and overtones are now audible. This yields a more complex overtone structure, as well as increased swell.

There are three basic types of sections produced in this invention.

1. Sections utilizing open ended slots or cantilevers: An open slot is defined herein above and as follows as a slot which begins at a point on the surface of the instrument, pierces through the cross section of the instrument, or creates a valley, channel, or groove in the instrument, and proceeds outwards until the slot reaches the edge of the instrument.

In the case of a cymbal, open slots can be created and formed in a manner which retains the original shape of the cymbal if such preservation of shape is desired. Open ended slots can produce one or more cantilevers. This design can create the slowest, most pronounced swell.

2. Sections utilizing closed slots: A closed slot is defined herein above and as follows as a slot which begins at a point on the plane of the instrument and proceeds outward but terminates before reaching the edge of the instrument. Such slots allow the instrument to retain more of its overall rigidity but still create highly flexible areas which increase swell and increase overtone complexity.

3. Sections using slots which result in cantilevers within the body of the instrument without severing the outside edge of the instrument: Certain embodiments can include combinations of one or more of these types of slots.

4. Sections utilizing precision grooves of considerable depth.

Both closed and open slots can undergo additional forming operations such as bending, rolling and/or hammering. When closed slots are hammered or rolled in a manner which reduces the thickness of the metal, the resulting pressure will force the metal to buckle, causing a bend or rise in the metal. This can be a useful feature which affects the overtone structure of the instrument. In general slots serve to create separate sections within the instrument. These sections can each be treated differently in many ways such as heat treatment, forming, shaping, use of bimetal, and other welding techniques to create a change in swell and overtone structure.

Such slots can slow down the attack of the sound in the instrument and hence increase the amount of swell produced in the instrument. Certain embodiments of this invention feature unprecedented slow attack and swell at previously unforeseen small sizes. No previous instrument has produced such slow gradual attack with a single strike. These slots also creates sections which vibrate semi-independently and hence increase the complexity of overtones in the instrument.

Cantilever sections arising from open slots can be formed or curled into curves of various radii and shapes. An instrument with multiple slots can be designed so that each adjacent cantilever is curled in alternating or opposite directions outward from the surface of the instrument. Such an embodiment will yield an increased vibrato and an altered overtone structure.

### Making the Instruments:

Materials: The materials used greatly affect the swell and attack of the instruments sound. The instrument should be made of materials with specific gravities exceeding 6. Specific gravities of 6 and higher produce better results. Bronze, with a specific gravity greater than 7, produces very good results. Low density alloys such as aluminum, with specific gravity less than 4, show no increase in swell and emit very few high frequency overtones.

Bimetal can be used to produce changes in sound. In the case of a hybrid bronze instrument which is relatively flat, a series of slots can be cut in the instrument. These slots vibrate at a slower speed than the main, unslotted portion of the instrument. This slower vibration causes the instrument to swell slower than unslotted instruments. The slower vibration is due to the increased flexibility of the narrow slotted section. Flexible sections vibrate slower than stiff sections.

Sections created by long slots vibrate slower than short sections. When multiple slots of differing length are cut into an instrument, each resulting section will vibrate at a different speed or frequency. These separately vibrating sections will modulate the vibrations of each other and the main unslotted area in very complex ways. The overall vibrato effect produced by these sections is hence very complex. A complex vibrato is generally accepted as being musically desirable. The vibrational characteristics of each section produced by the slots can be treated and manipulated separately to a much greater degree than a section of metal which is contiguous. Each section can be heat treated, stress relieved, zone annealed, hammered, rolled, machined, reduced in thickness or other methods of alteration, in different ways. The result is an instrument class of unexpected complexity and richness of sound.

While slots can lower the frequency of the lowest fundamental modes of vibration, the slots can also increase the complexity of overtone structure in a percussion instrument. Hence, higher frequency overtones can become more prominent in certain embodiments due to slotting.

Dome, bell or cymbal-shaped instruments sectioned by a single slot: A dome-shaped instrument can be slotted in a manner which renders the instrument more flexible. This increase in flexibility allows propagation of a more complex overtone structure. It also creates several modes of vibrato. The instrument, instead of vibrating like a rigid bell or dome shape, is now free to vibrate in several modes of much lower frequency than an unslotted instrument. These modes result in a useful vibrato effect. The slots can be of various lengths. Slots which proceed farther toward (or past) center will yield a lower frequency vibrato, and a generally more complex overtone structure. A hole can be created at the termination of the slot. The size of this hole

will affect the sound of the instrument. A large hole in the center of the instrument will tend to reduce and even obliterate the low pitch “hum note” found in gongs. This hole, along with the slot renders the instrument more readily usable with drumsticks.

Cymbal hybrid instruments with cantilever sections: A dome shaped instrument with a surface radius or “bow” similar to that of a cymbal can be created by the creation of a large hole in the center of said instrument which reduces the hum note and other gong-like sounds of the instrument and renders it more cymbal-like in sound. The complexity of overtone structure can be further enhanced by the creation of slots which extend outward from the center hole. The cantilever sections arising from said slots can be then formed or curved upwards to further alter the swell and overtone complexity of the instrument. Such an instrument has an exceedingly complex sound and is highly useful in many musical situations.

The above described instruments can be played with drumsticks, mallets or by hand. Nickel-iron grain refiners in bronze percussion instruments: While ductility is necessary to form the shapes in this invention, the final product must be exceedingly strong and resilient to withstand consumer use. It must hence resist deformation during use while being quite flexible. In many alloys, the metal is quite ductile (easily deformed without cracking or failure) when in the soft or partially softened state. These softer states of metal, while quite ductile, are not as strong as the hardened levels of temper in any given alloy.

Temper ratings of certain alloys, especially those which are strengthened through cold work methods such as rolling, hammering or other methods which can reduce the thickness of said metal and reduce grain size and elongate the grain structure of the alloy, are rated by the percent of elongation remaining in the alloy before the metal will fail in tension. Phosphor bronze is hardened and strengthened by cold work. Phosphor bronze alloys are typically composed of copper, tin and a small amount of phosphorous. A typical phosphor bronze, when hardened to a strength rating of extra spring temper, can only be elongated by an additional 2% before failing and breaking or cracking in tension. The addition of small amounts of iron and nickel can refine and reduce grain size and hence, increase strength. Through the addition of the iron and nickel, ideally in ranges of between 0.05 to 0.20% each, can increase strength considerably. By utilizing these grain refiners, a temper with more elongation remaining in the alloy can be used. A temper rating of extra hard in such an alloy, will possess strength equal to extra spring in a typical bronze alloy. This extra hard temper can be elongated considerably more than extra spring temper hence allowing the deformation needed to easily form this invention. In short, the softer, a more ductile temper of grain refined bronze can be stronger than a hard, more brittle temper of traditional bronze.

While nickel iron grain refiners are known to increase low tin bronze strength, they are not know to increase sound quality. Low tin bronze alloys are thought to be to high pitched and of narrow range compared to equal high tin alloys in sound quality. The inventor has found that by using nickel iron grain refiners in low tin, more affordable and workable alloys, a percussion or cymbal maker can increase taper, use of heat zones, depth and greater variations of hammering and other processes which create a structurally more complex instrument to realize a product of superior complexity of overtone structure, higher strength and a product which lends itself to greater affordability of quality control. Such processes such as greatly increased tapering would weaken common alloys but the added strength provided by nickel iron grain refiners allows the use of these special processes and features.

Many bronze instruments shared many vibrational characteristics with cymbals. Advertising copy from the two largest cymbal manufacturers teaches away from the use of low tin alloys for high quality percussion instruments by mentioning that their own product lines made of low tin alloys are of affordable, mass produced and identical quality when compared to their high tin alloy products: reference—Sabian.com advertising in referring to low tin alloy called B8 phrases point to an image of affordability, “rapid tech virtual cloning”; limited range of overtone structure is advertised: “focused sound”; “lowest possible prices”; all teach away from low tin alloys for use in quality cymbals and percussion. The Zildjian company (the largest cymbal maker) advertises “ultra modern crafting techniques”, “higher pitch”, “more focused overtones”, “identical discs” for their low tin products. Such phrases teach away from very high quality to cymbal and percussion consumers, who regard hand crafting and a wider range of overtones desirable. See http://www.zildjian.com/en-US/products. Conversely the same companies promote their high tin products as works of art with centuries old secret processes which yield high quality, all of which begins with their 20% tin alloy.

The use of nickel-iron grain refiners in this invention offers a method to create new percussion instrument embodiments of high quality and novel sound while possessing the superior flexural strength need for this invention.

### Benefits of this Invention:

Unprecedented control of swell in percussion instruments. The percussionist can control the speed of attack through use of various striking methods.

Plucking the ends of open ended cantilevers resulting from slots in hybrid instruments produces an attack of very gradual swell-unprecedented in percussion instruments, even when embodied in small versions of the invention. Striking the edge of the same instrument at 90 degrees to the edge can produce a very fast attack yielding very high frequency overtones. This great variety of sounds produced by a single small instrument can yield a financial cost savings to percussionists by allowing the player to create sounds heretofore only produceable with multiple, larger instruments.

Closed slots also result in sections which enhance swell.

The slow vibrating sections are capable of producing a slow swell with a single pluck or strike, a sound heretofore only produceable with a gradual rolling of multiple strikes of increasing force.

The net result is an easier way for the player to produce a gradual swelling sound.

The use of sections of multiple length (especially in open ended slots) produces a vibrato sound of unprecedented complexity.

The use of slots extending outward from the large hole in a suspended cymbal hybrid instrument can allow a circular raking motion along the inside of the large hole to produce a very complex rise and fall in amplitude of sound. This rise and fall can be produced with one hand and a striking device such as a drumstick, a feature which drummers find useful.

The use of one or more slots extending outward from the large hole in cymbals or a suspended cymbal hybrid instrument produce an unprecedented increase swell and complexity of overtone structure. Such slots also help to eliminate the “hum note” and concentrate sound in the mid to high frequency spectrum, where percussive sounds are less likely to interfere with vocal and melodic instruments.

Independently treated zones: If a non-slotted percussion instrument is hammered, heat treated, or formed or machined in a given area, this action affects the surface as a whole. Tension exists throughout the entire surface of a thin section of metal (in hardened metals especially) whereby the outer edge of a thin instrument will be greatly affected by action taken in for inner areas. In a slotted instrument, a given section can be heat treated with little or no heat transmission to other areas, thus isolating the effect of the treatment. A depression or raised dome can be created in a given slotted section which creates considerable tension in that slotted section while reducing the spread of tension or limiting the tension to an area along the length of that section, rather than to adjacent slotted sections.

The outer edge of a section can be folded over to created a rounded and very stiff isolated section which allows the percussionist to strike the instrument at an acute angle to produce loud sounds of fast attack with little or no swell while allowing the remainder of the instrument to be flexible and able to yield slow swell. This folded area also reduces wear on drumsticks by creating a rounded edge, which is less likely to cut into the drumstick.

A given section can be machined or processed with any material removal method which reduces tension in that section while having little or no affect on adjacent sections. This ability to process areas with independence allows the creation of instruments with increased swell, overtone complexity and variety of sounds produced.

C-shaped instruments arising from a slot: A dome shaped instrument can be divided by a single radial slot which severs the entire section between the outer edge of the instrument and it's center hole to form a C-shape. This slot has the effect of increasing flexibility of the instrument by severing what was a rigid dome shape. The resultant instrument vibrates in a novel fashion. A low frequency vibrato has now been introduced, which modulates the whole of the overtone structure. In some embodiments, several modes of vibrato are present.

In addition, wavy and serrated surfaces can be created along which a drumstick or other striking device can be moved in a rubbing circular fashion to produce sound at a variety of levels. The speed and pressure with which the player rubs the uneven surface of the hole can result in controlling the duration and volume of the instrument to previously unprecedented degrees. Sound can be stopped altogether by applying pressure after the circular motion is complete. This effect can be achieved with one hand.

The embodiments in the drawings are round but other shapes could be utilized or are contemplated as within the scope of the invention. The embodiments shown have a domed-shape. Such a domed surface will have a louder and more complex sound than a flat shape. For example, a dome-shape with a large radius of 40 inches will tend to resemble a cymbal in sound, while a dome-shape with a smaller radius of 12 inches will tend to resemble a bell in sound.

Vibrato can be generated by slots. The oscillating movement of cantilevers in open slots causes a low frequency vibrato, which can modulate the entire overtone structure of the instrument.

Cantilevers arising from slots of differing length can each generate a vibrato of differing frequency, causing multiple simultaneous vibrato waves, which have a complex and interesting musical effect. These cantilevers, when struck, do vary in sound but do not create distinct, individual notes as might be expected upon initial visual inspection. They conduct vibration into each other and act upon each other in a such a way as to create a complex whole.

Areas of differing rigidity: An instrument with edges which are folded over has a higher rigidity than an unfolded section. If the outer edges of an instrument are folded, but the inner areas are slotted, the instrument will have a rigid outer edge, with a flexible core. This will allow a slicing motion or striking at an acute angle to the edge to create a sound of quick attack, where a strike or pluck in the center area can create a sound of slower swell. Such a rounded edge increases durability, increases general amplitude, and greatly reduces wear on drumsticks by presenting an edge of increased radius to the stick.

### Cymbals with Deep Grooves.

Prior art cymbals have often been lathed on the surface in a manner which results in only a series of subtle valleys or furrows which only affect sound quality in subtle ways. While the total lathing process has in the past resulted in some cymbals in a considerable tapering effect or thinning—most often toward the outer edge of the cymbal, individual grooves have never been of any considerable depth. Grooves in prior art cymbals have not exceeded a small percentage—perhaps 5%—of the total thickness of the cymbal. This invention utilizes deep groove and/or progressive grooves.

### BRIEF DESCRIPTION OF THE DRAWINGS

In the accompanying drawings:

FIG. 1 is a conceptual depiction of an example of slot and/or groove types typical of the invention described below as applied to a cymbal;

FIGS. 1A-1C depict examples of slots above or below the surface of the cymbal or combinations thereof as well as the inclusion of wide slots as depicted in FIG. 1C;

FIG. 1D is a conceptual depiction of an example of slot and/or groove types typical of the invention as applied to a triangular shaped cymbal;

FIG. 2 is a conceptual example of a percussion instrument with open slots that is folded over to form one or more round edges or folded along a line, in this case, along a line;

FIG. 3 is an example of a percussion instrument with closed slots;

FIG. 4 is an example of a percussion instrument with closed slots that further depict curved or shaped slots to form flaps or cantilevers within the instrument;

FIG. 5 is an example of a cymbal with slots resulting in the creation of cantilever sections within the body of the cymbal;

FIG. 6 is an example of a percussion instrument that has open slots without severing the outside edge of the instrument, sections are created by the slots radiating outwardly from the center of the edge of a center hole, and in this particular example, the cantilevers are formed in upward curving directions opposite the direction of curve of the main body of the instrument;

FIG. 7 is an example of a percussion instrument with closed slots in which sections are formed into curves of opposing direction and/or curves of differing shape by hammering or other means;

FIG. 8A is a representative example of a percussion instrument with open slots forming cantilevers wherein weight(s) or object(s) are welded to one of the cantilevered formed sections and the added weight(s) or object(s) may of the same or differing alloys than that of the main body of the instrument;

FIG. 8B is a representative example of a percussion instrument with open slots forming cantilevers without the weight(s) or object(s) being welded to one of the cantilevered formed sections;

FIG. 8C is a representative example of a percussion instrument with open slots forming cantilevers where one or more of the cantilevers have a folded end portion;

FIG. 9 is a representative example of a percussion instrument with closed slots forming cantilevers within the body of the instrument and further depicting an example of weights, which can be bells, domes, or other vibrating objects or sections, welded to one or more of the cantilevers, and the weights may be of the same or differing alloys than that of the main body of the instrument;

FIG. 10 is a representative example of a percussion instrument with a central aperture edge being uneven or wavy in shape suitable for rotational striking with a drumstick;

FIG. 11 is a representative example of a percussion instrument similar to FIG. 10 with an additional feature of weights or objects being welded to one or more desired sections of the instrument and the weights can be of the same or differing alloys than that of the main body of the instrument and can be a vibrating piece of one or more pieces of metal such as bells, domes or other vibrating sections;

FIG. 12 is a representative example of a cymbal with slots which form semi-isolated sections within the body of the cymbal; and

FIG. 13 is a representative example of a cymbal similar to that of FIG. 12 with slots which form semi-isolated sections within the body of the cymbal, except that the semi-isolated slots are formed into curves of opposing direction and/or curves of differing shape by hammering or other means.

### DETAILED DESCRIPTION OF THE INVENTION

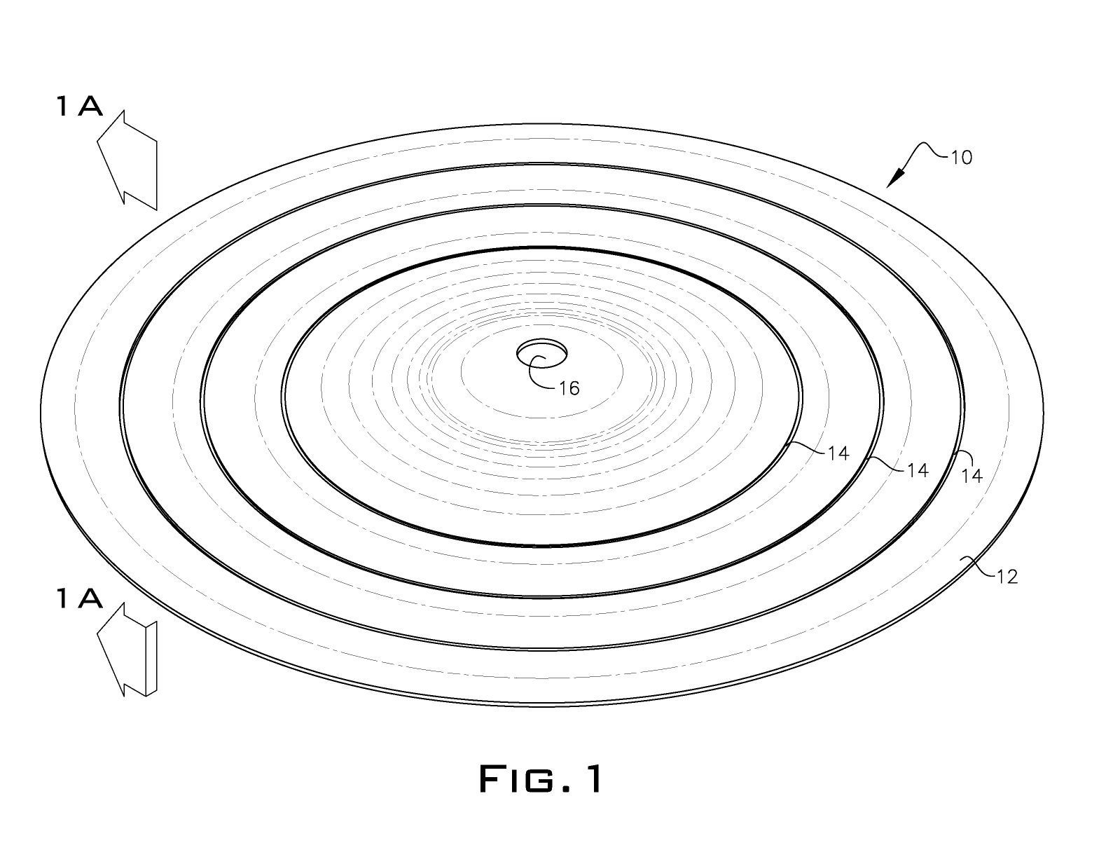

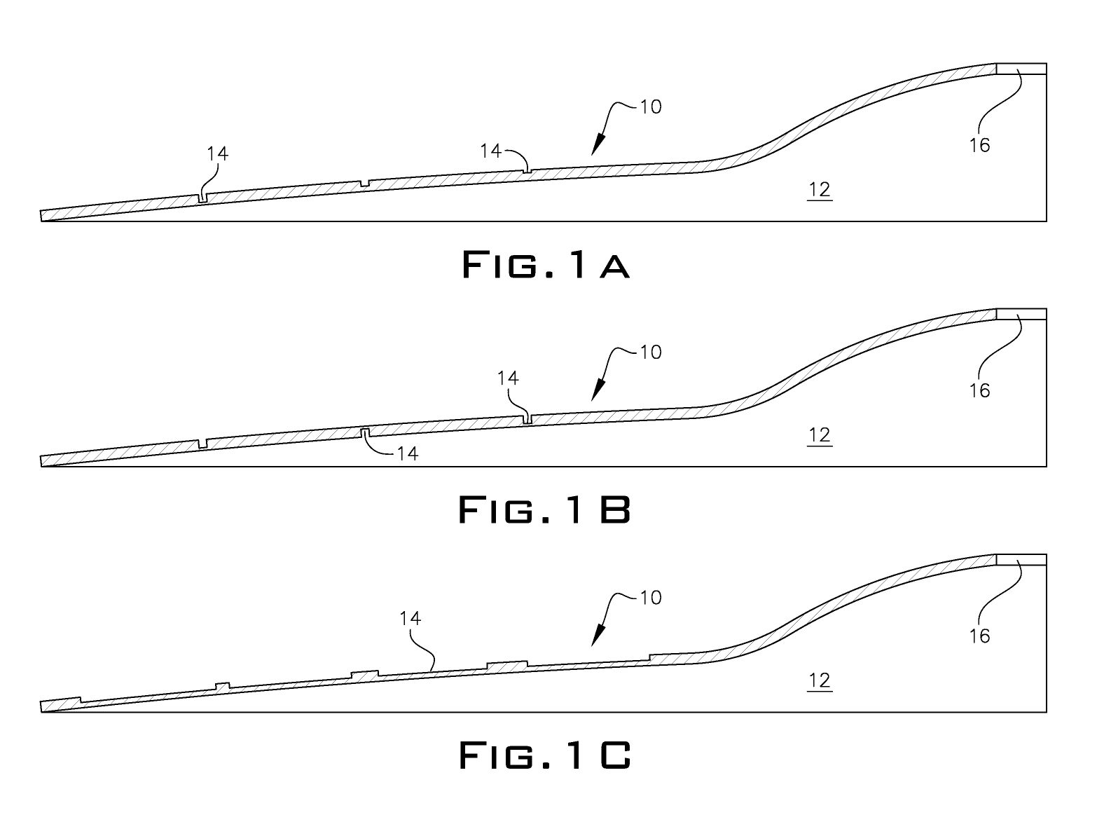

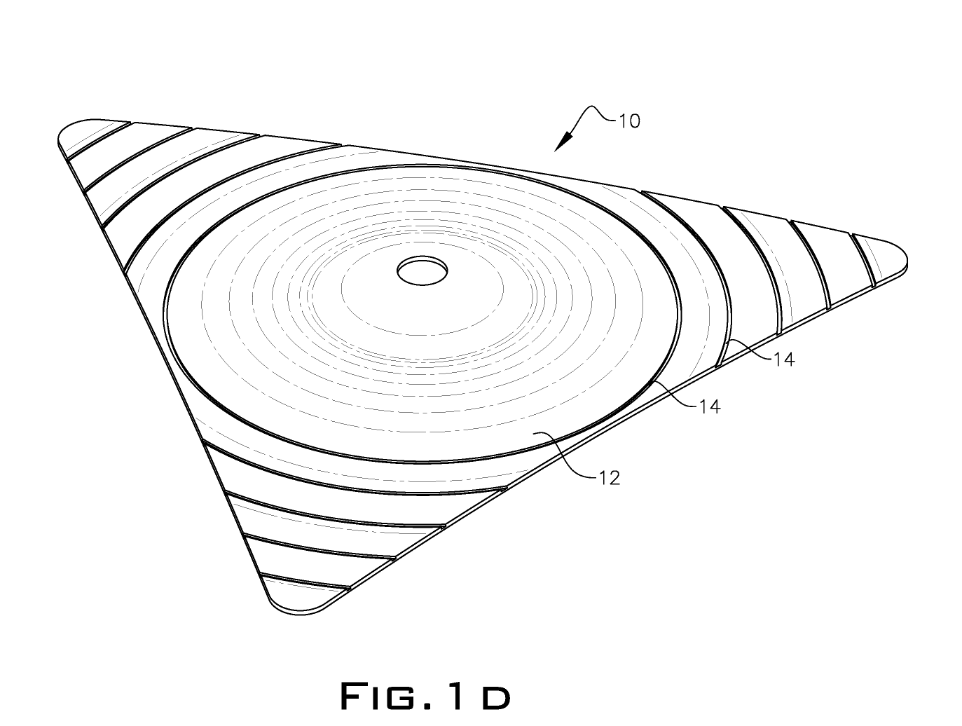

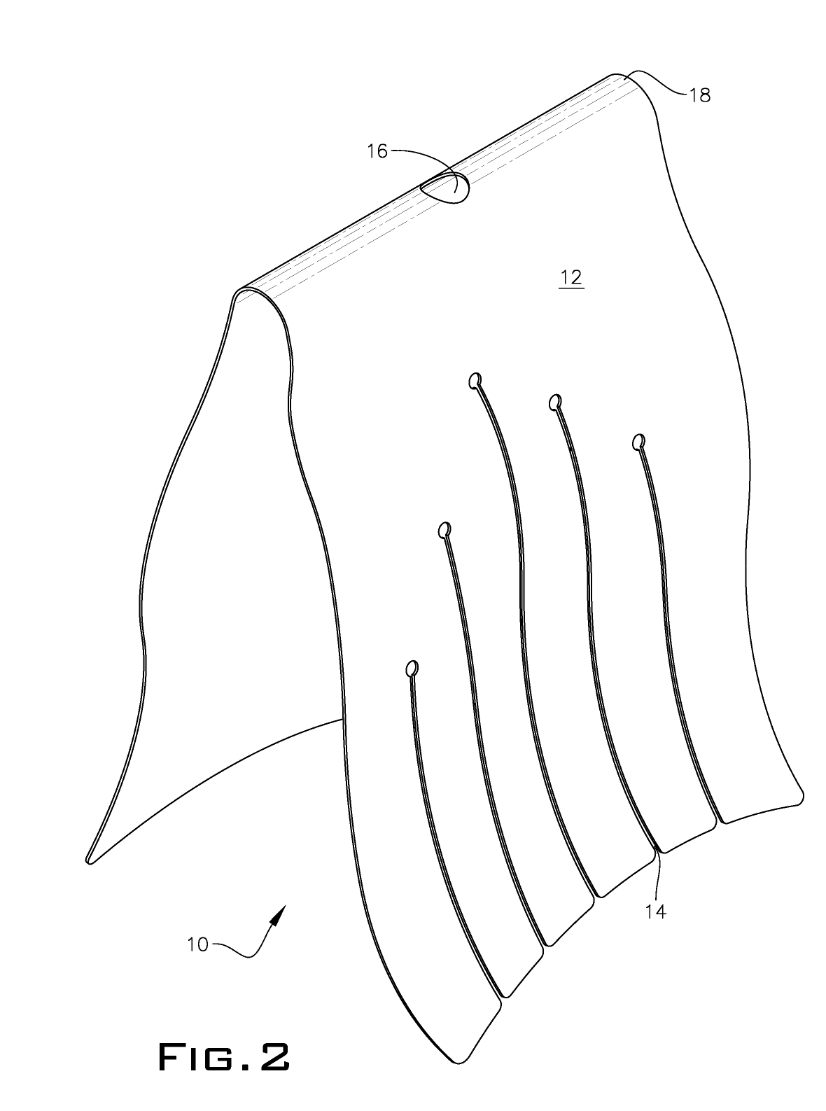

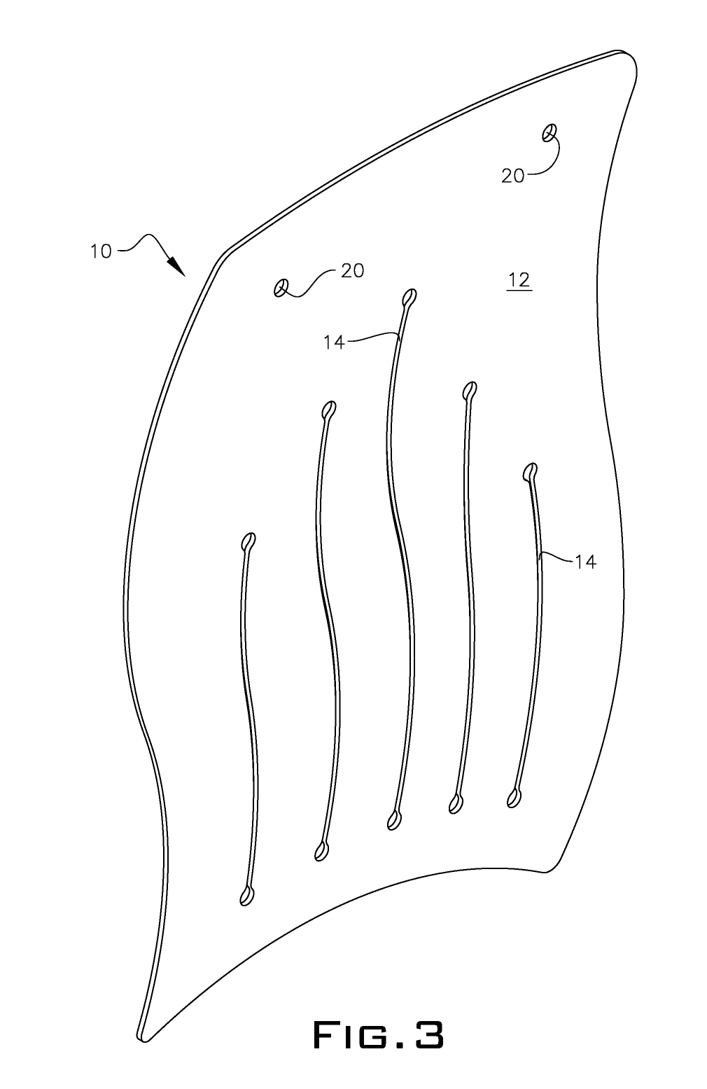

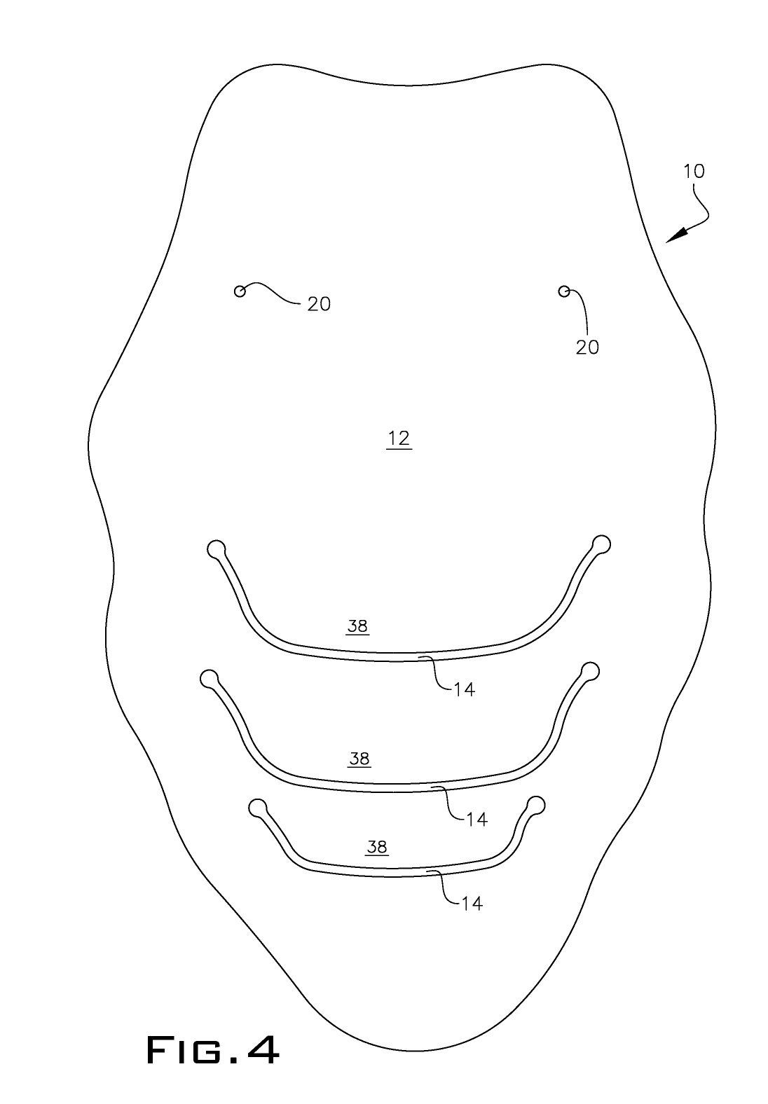

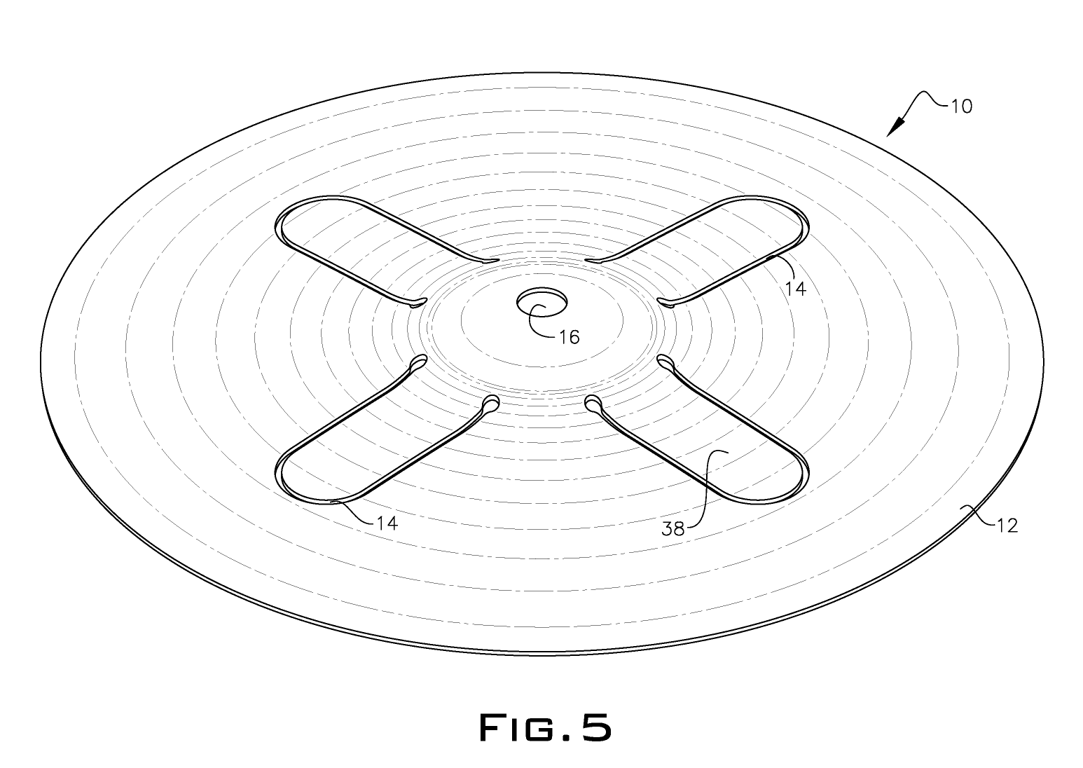

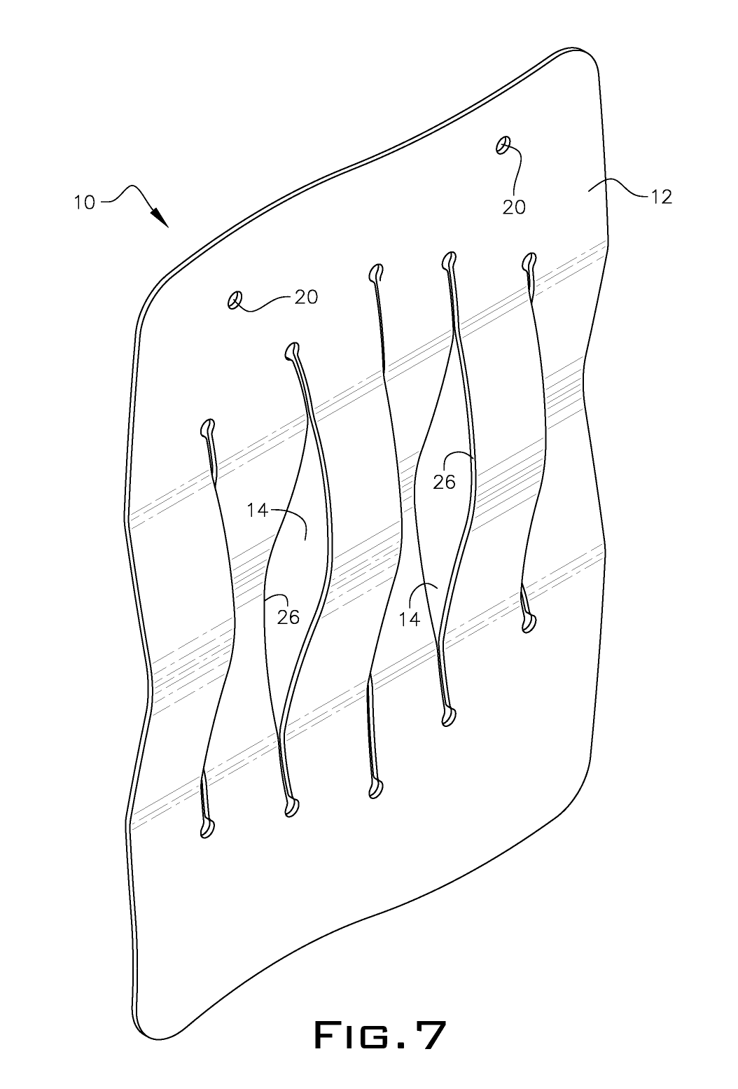

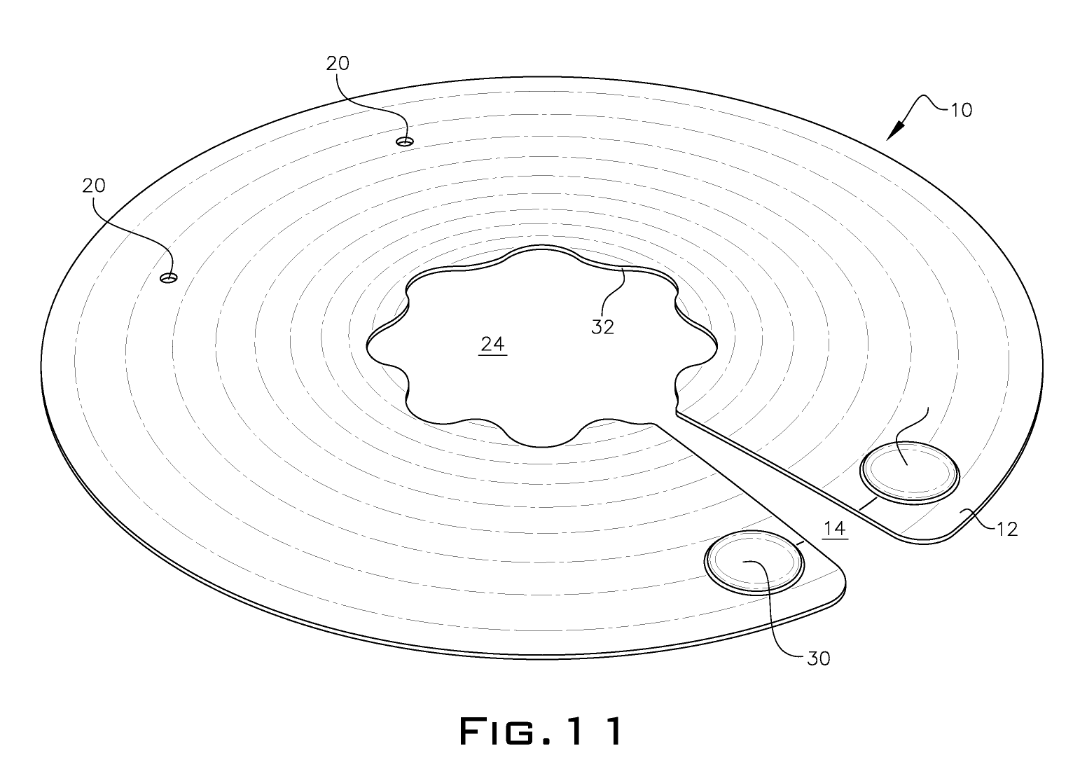

Referring now to the drawings, FIGS. 1-13 disclose various examples of embodiments that are contemplated to being within the scope of the invention, depicted generally as 10, are described below.

FIGS. 1, 1A, 1B, 1C and 1D provide conceptual depictions of examples of groove 14 types typical of the invention described below. It is important to note that grooves, as defined here are not merely bent or formed areas in the surface of the invention, but rather areas where there is a considerable change in the actual thickness of the cross section. In cases where 2 grooves on opposite sides of the cymbal are directly opposing each other, the aggregate total depth of the 2 grooves will be used for purposes of defining depth.

FIGS. 1A, 1B, and 1C represent cross-sectional partial views of cymbals 12 utilizing grooves 14 which affect sound in cymbals in a way far different than standard lathing techniques. The grooves in this invention can affect change in sound in ways not anticipated by prior art.

One embodiment can be a utilize a series of wide grooves 14 which serve to taper the cymbal yet leave circular ridges of unlathed material which can stiffen or strengthen key areas. One such embodiment can be seen in FIG. 1C where the outer edge of the cymbal remains thicker, where inner circular bands of material are thinner. Such an outer edge would be stronger than if it were lathed or formed down to a very thin gauge. Test show that a thick, rigid cymbal of 0.070 inch thickness could, for example be lathed down to 0.020 inch in key areas, leaving a more flexible cymbal with a strong outer edge.

FIG. 1A shows a cymbal 12 wherein thin grooves 14 are cut or formed in the section of the cymbal in progressively deeper depths toward the outer edge, thereby reducing outer edge rigidity while retaining the high mass of an unlathed cymbal. Reducing rigidity can be desirable, as flexible cymbals tend to emit a more complex series of overtones, hence allowing for a more interesting sound quality. High mass cymbals are often capable of higher amplitude vibration. Such an embodiment would therefore allow for the combination of high mass and richer, more complex overtones.

FIG. 1B is a variant which represents both the upper and lower surfaces of a cymbal being grooved in a manner similar to FIG. 1A. The grooves in FIGS. 1A, 1B and 1D could also formed using compression rather than material removable methods such as lathing. Such a series of compressive grooves would allow for considerable work-hardening to be achieved at the bottom of said grooves. Such an alternation soft and hard material would produce a unique sound, as well as allow for novel forming opportunities while retaining the strength of a cymbal which is hardened throughout.

Such precision grooves would not need to be round. Techniques such as milling or etching, or additive techniques such as welding or plating can create grooves of many shapes. The grooves can also be formed by compression of the cymbal material.

The cymbals 12 depicted in FIGS. 1 and 1A-1D features one or more grooves 14 of a depth greater than 15% of the total thickness of the cymbal which create specific areas of altered rigidity, and wherein the outer edge of the cymbal features an area which remains at a thickness which is greater than 33% thicker than the adjacent groove. The cymbals can be manufactured with grooves that have a minimal depth that considerably alters rigidity of said cymbal. As depicted in FIG. 1D, the cymbal may be polygonal in shape, wherein the sides of the cymbal are bisected by the grooves. In an alternative embodiment, the cymbal may include a series of grooves of increasing depth progress outward from center.

Generally, one example of the invention 10 is a metal percussion instrument which features one or more open or closed slots 14, the instrument comprising a main vibrating section 12 which is composed of a metal alloy of a specific gravity greater than 6. The main vibrating section may be a cymbal with a center stand suspension hole 16 or a percussion instrument with vertical suspension holes 20.

The one or more slots 14 are configured to create multiple modes of vibration which affect an entire frequency response of the instrument 12 and the slots 14 are further configured to create one or more fundamental frequencies with a greater number of audible overtones thereby building a complex overall sound.

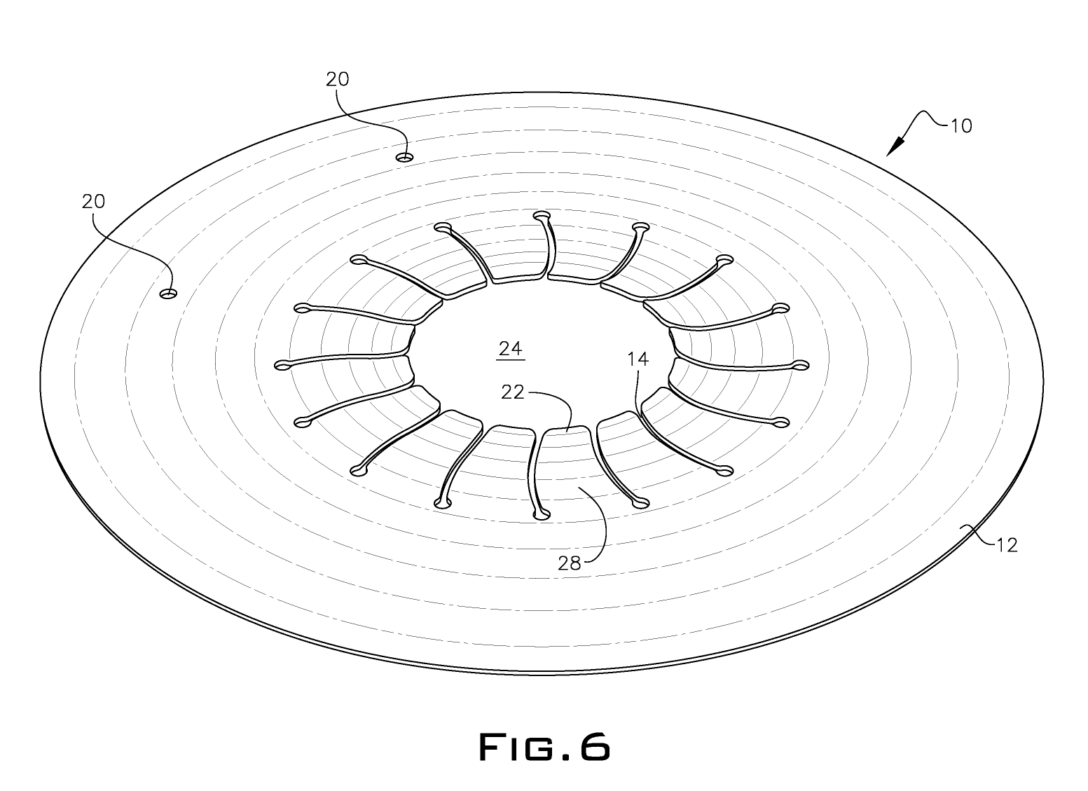

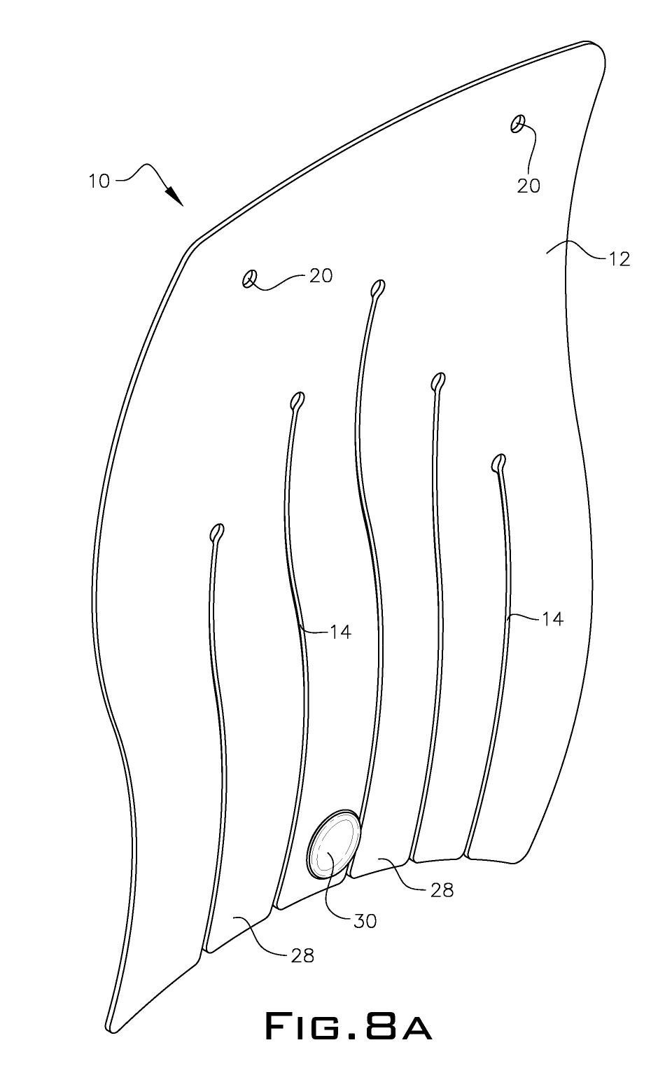

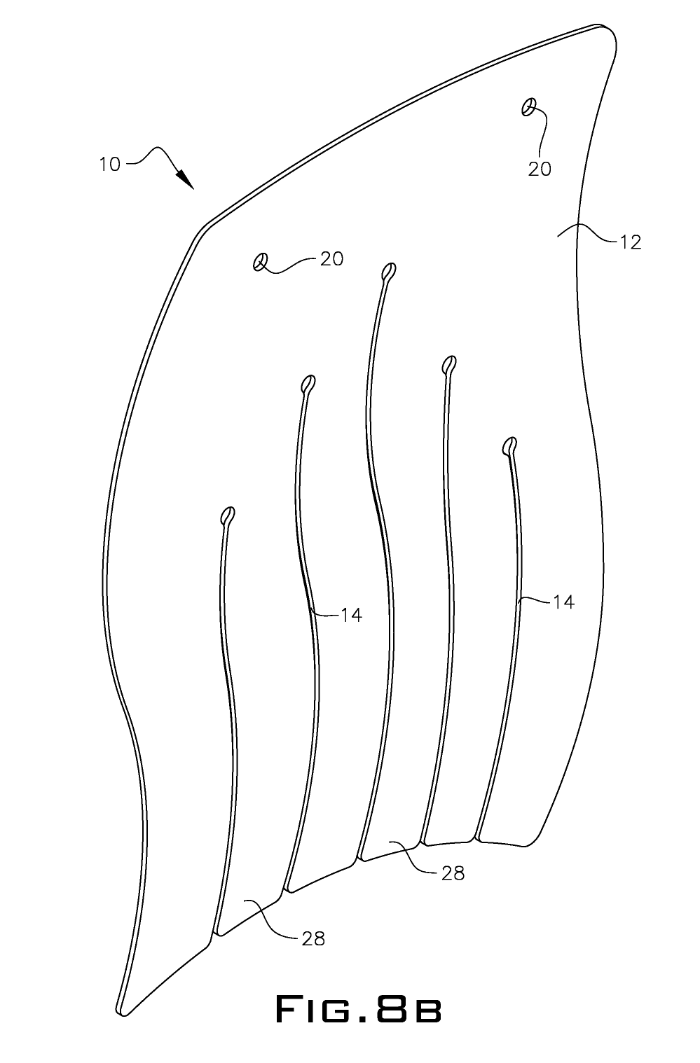

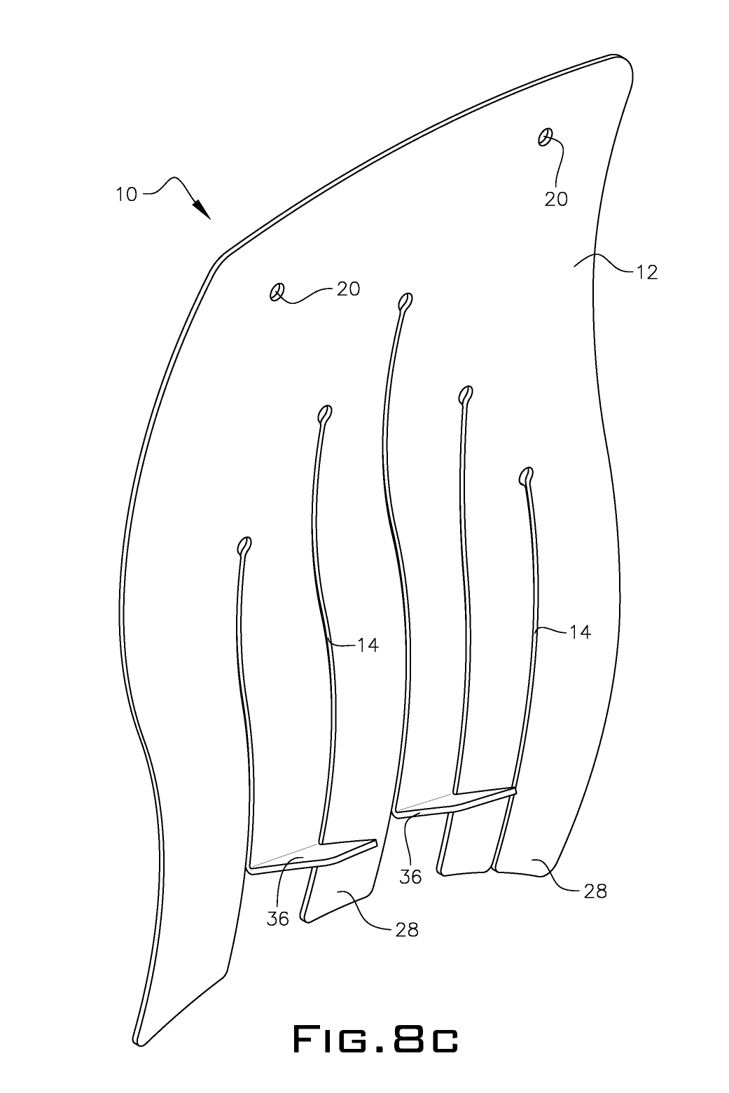

In one embodiment, the formed outer edges 22,36 of the instrument 12 are folded over to make one or more rounded edges, and/or the instrument 12 is folded along one or more lines as in FIGS. 6 and 8C.

In a closed slot embodiment, the instrument 12 comprises a main vibrating section which is composed of a metal alloy of a specific gravity greater than 6, and the slots 14 are curved or shaped in a manner which creates one or more cantilevers or “flap” shaped sections 38 within the instrument 12.

In an open slot embodiment, the instrument 12 has resultant cantilevers 28 within the body of the instrument 12 without severing the outside edge of the instrument.

In one embodiment, the instrument 12 is in the form of a cymbal, which features one or more slots 14, and the slots 14 result in the creation of cantilever sections 28,38 within the body of the cymbal. In an alternative embodiment to the cymbal form, weights, bells, or vibrating objects are welded to the cantilevers 28,38.

In another embodiment of the instrument 12, the instrument is formed of a suspended piece of metal in which a series of sections or cantilevers 28 are created by slots radiating outward from the center or from the edge of a center hole 24. In a similar embodiment, the instrument 12 is comprised of a suspended piece of metal 28 of a specific gravity greater than 6, in which a series of slots 14 are created radiating outward from center or from the edge of a center hole 24, wherein the cantilever sections 28 resulting from the slots 14 are formed in upward curving 22 directions, opposite to the direction of the curve of the main body of the instrument 12.

In an embodiment of the instrument 12, which features one or more closed slots 14, the instrument 12 comprises a main vibrating section which is composed of a metal alloy of a specific gravity greater than 6, and sections 26,34 formed into curves of opposing direction or curves of differing shape, by hammering or other means.

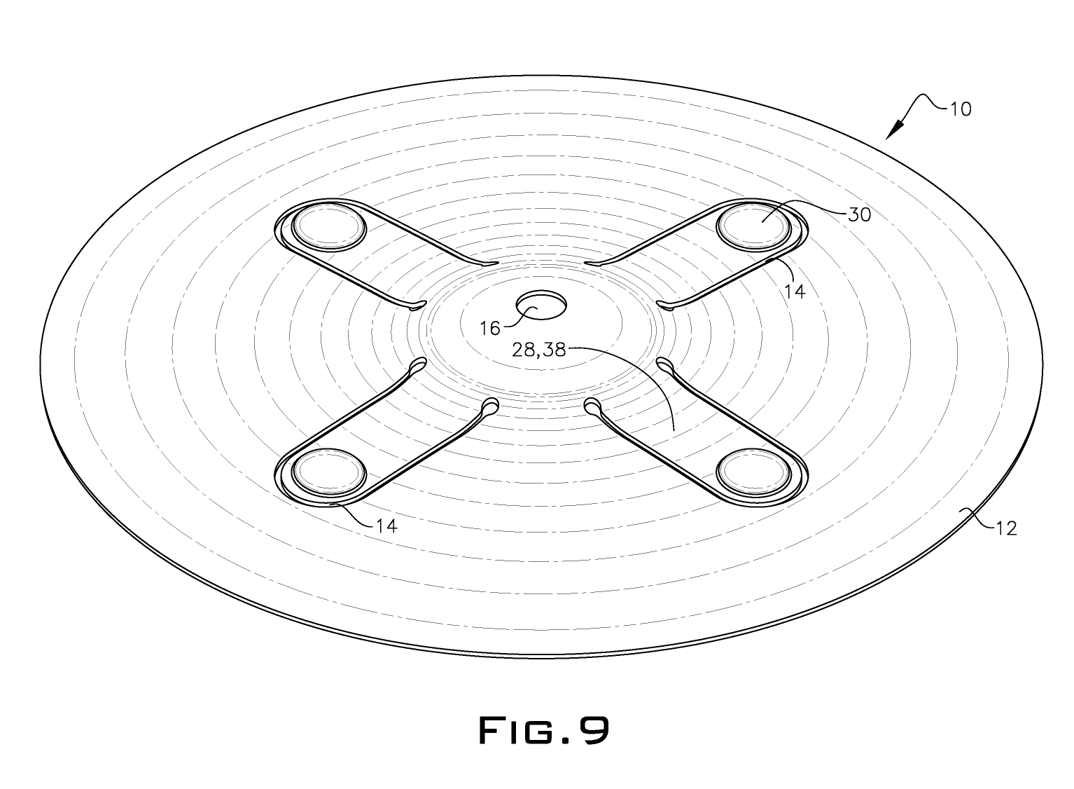

As depicted in FIG. 9, another embodiment is an instrument 12 composed of a metal alloy of a specific gravity greater than 6, which features one or more closed slots 14 cut through the cross section of the instrument, whereby weights or objects 30 are welded to one or more of the the sections 28, where the weights 30 are of the same or differing alloy than the main body of the instrument 12. Similarly as depicted in FIG. 8A, another embodiment is an instrument 12, which is composed of a metal alloy of a specific gravity greater than 6, which features one or more open slots 14, where weights or objects 30 are welded to one or more of the sections 28 and the weights 30 are of the same or differing alloy than the main body of the instrument 12. Optionally, the weights or objects 30 can comprise a vibrating piece of one or more pieces of metal such as bells, domes, or other vibrating sections.

A cymbal is an example of an instrument 12 that is within the scope of the present invention and can incorporate any of the above described features. Cymbals can be shaped in a variety of shapes such as the shapes depicted in FIGS. 1, 1A-1D, 5, 12 and 13, which features one or more slots 14 including weights or objects 30 that comprise a vibrating piece of one or more pieces of metal 30 such as bells, domes, or other vibrating sections.

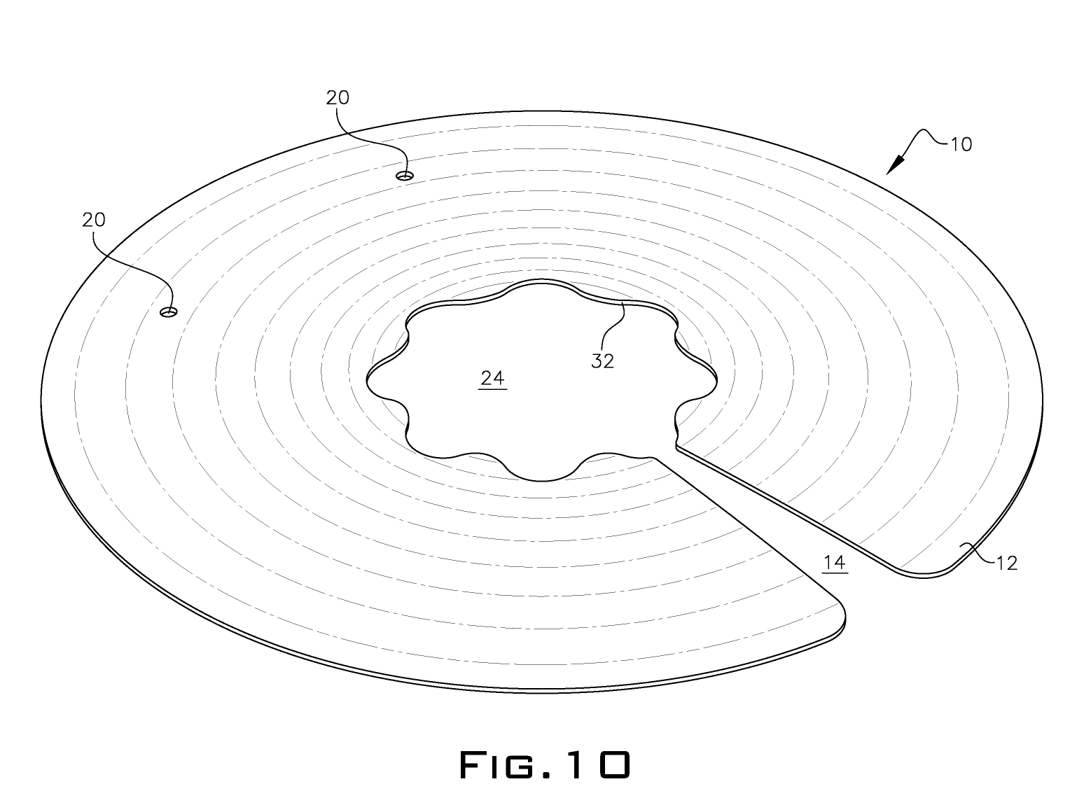

As shown in FIGS. 6 and 10-11, examples of the inventive percussion instrument 10 can feature a central aperture 24 with a slot 14 emanating radially from the center thereby forming a C-shaped instrument 12. In this embodiment, the instrument may also include a formed domed-shaped surface. This latter embodiment may also be configured such that the central aperture 24 has an uneven or wavy shape 32 suitable for rotational striking with a drumstick as shown in FIG. 10. Additionally, weights or objects 30 may be welded to one or more of the sections 28 formed by the slot 14, with the weights 30 being of the same or differing alloy than the main body of the instrument, and the weights or objects 30 can comprise a vibrating piece of one or more pieces of metal such as bells, domes, or other vibrating sections.

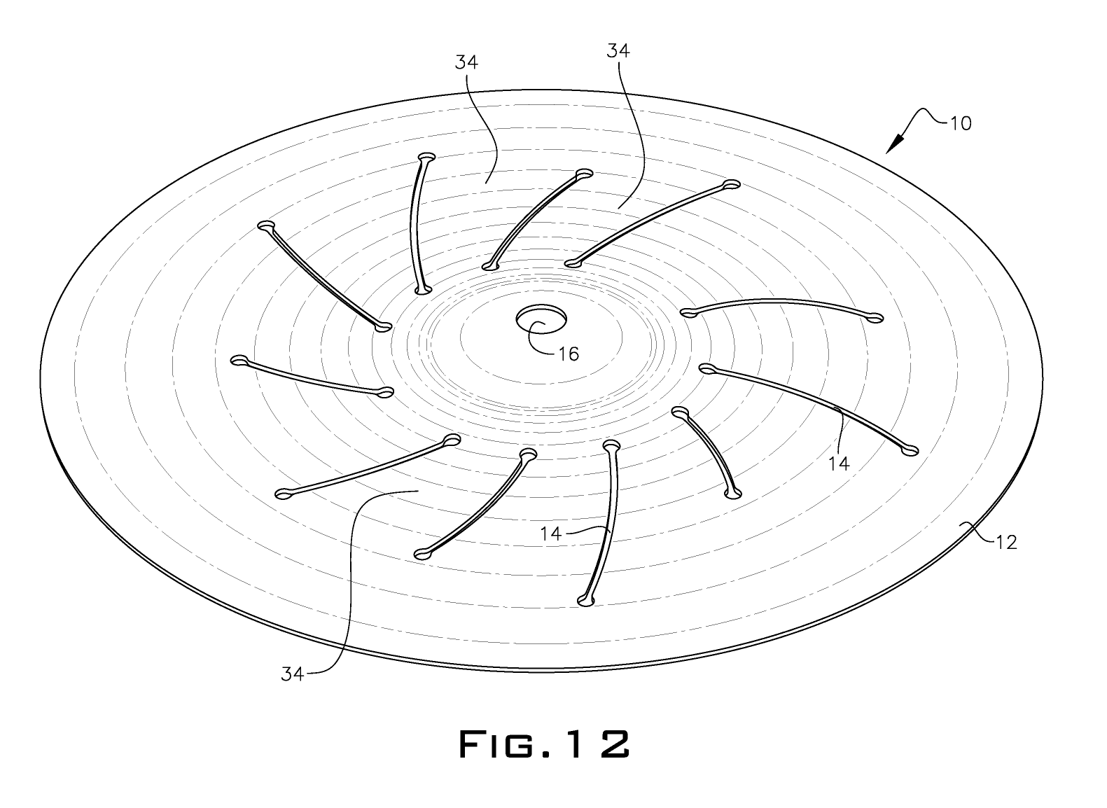

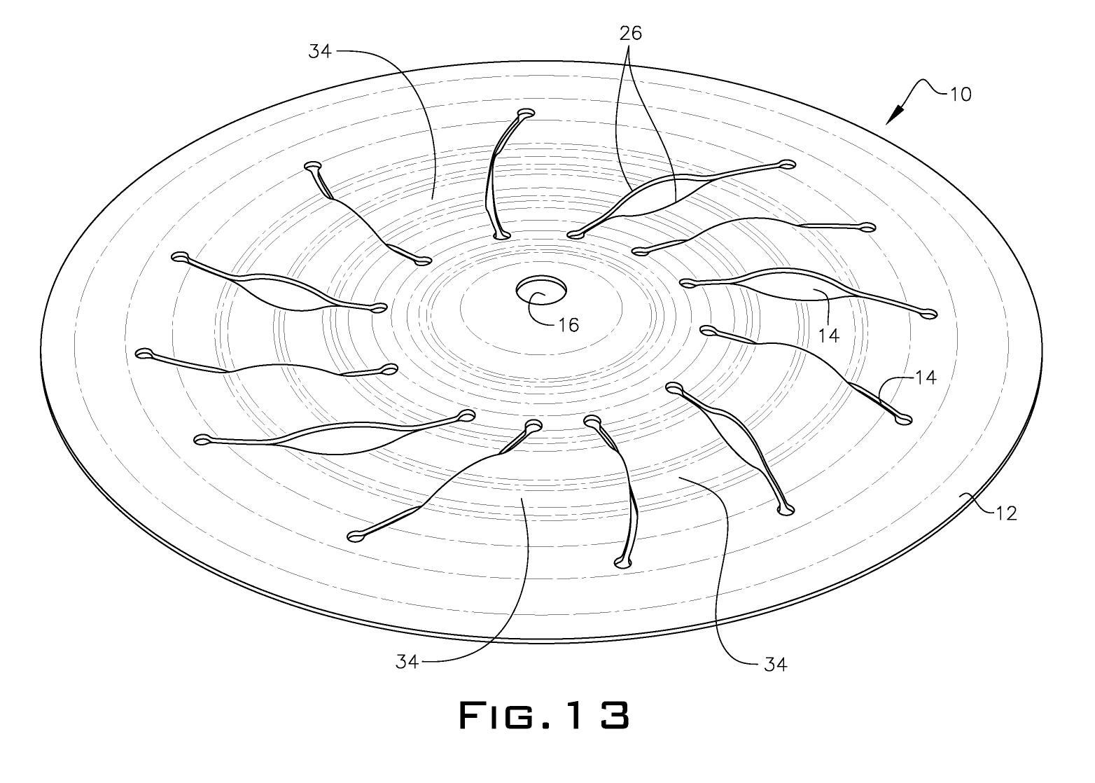

Another embodiment is a cymbal where one or more slots 14 result in a creation of semi-isolated sections 34 within a body of said cymbal 12 as depicted in FIGS. 12-13.

As depicted in FIGS. 1 and 1A-1D, the slots 14 as contemplated by the present invention may be in the form of grooves within a cross-section of the instrument 12, where the slots 14 are formed on an upper surface, a lower surface or a combination of the upper and lower surfaces of said instrument 12.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A metal percussion instrument wherein said instrument comprises one or more slots of same or varying lengths, and a main vibrating section which is composed of a metal alloy of a specific gravity greater than 6, wherein said one or more slots are configured to create multiple modes of vibration which affect an entire frequency response of said instrument and wherein said one or more slots are further configured to create one or more fundamental frequencies with a greater number of audible overtones thereby building a complex overall sound.

2. The instrument according to claim 1, wherein said one or more slots are open slots.

3. The instrument according to claim 1, wherein said one or more slots are closed slots.

4. The instrument according to claim 2, wherein one or more outer edges of said instrument are folded over to make one or more rounded edges, or the instrument is folded along one or more lines or a combination thereof.

5. The instrument according to claim 1, wherein said one or more slots are formed so as to provide cantilevers within a main body of the instrument without a severing of an outside edge of said instrument.

6. The instrument according to claim 1, wherein said instrument comprises a central aperture with a single open slot emanating radially from a center thereof forming a C-shaped instrument.

7. The instrument according to claim 6, wherein a surface of said instrument is formed into a domed-shape.

8. The instrument according to claim 6, wherein said central aperture has an uneven or wavy shape suitable for rotational striking with a drumstick.

9. The instrument according to claim 6, further comprising weights being welded to one or more desired locations on said C-shaped instrument, said weights being of the same or differing alloy than a main body of said instrument.

10. The instrument according to claim 9, wherein said weights comprise a vibrating piece of one or more pieces of metal.

11. The instrument according to claim 10, wherein said vibrating piece of one or more pieces of metal comprises a bell, a dome or combinations thereof.

12. The instrument according to claim 3, wherein said closed slots are configured so as to form one or more cantilevered-shaped sections within said instrument.

13. The instrument according to claim 3, wherein said main vibrating section further comprises sections formed into curves of opposing direction, or curves of differing shape.

14. The instrument according to claim 3, wherein the one or more closed slots are cut through a cross-section of said instrument, said main vibrating section further comprising sections wherein weights are welded to one or more of the said sections, said weights being of the same or differing alloy than a main body of said instrument.

15. The instrument according to claim 14, wherein said weights comprise a vibrating piece of one or more pieces of metal.

16. The instrument according to claim 15, wherein said vibrating piece of one or more pieces of metal comprises a bell, a dome, or combinations thereof.

17. The instrument according to claim 1, wherein said instrument comprises a suspended piece of metal, in which a series of sections or cantilevers are created by slots radiating outward from a center or from an edge of a center hole.

18. The instrument according to claim 17, wherein the cantilever sections resulting from said slots are formed in upward curving directions, opposite to a direction of a curve of the main body of the instrument.

19. The instrument according to claim 1, wherein said instrument is a cymbal.

20. The instrument according to claim 1, wherein said one or more slots are configured in the form of grooves within a cross-section of the instrument, said slots being formed on an upper surface, a lower surface or a combination of said upper and lower surfaces of said instrument.

21. A cymbal comprising one or more grooves having a depth greater than 15% of a total thickness of said cymbal wherein specific areas of altered rigidity are created, and wherein an outer edge of said cymbal includes an area which remains at a thickness which is greater than 33% thicker than an adjacent groove.

22. The cymbal according to claim 21, wherein said grooves have a minimal depth that considerably alters rigidity of said cymbal.

23. The cymbal according to claim 21, which is polygonal in shape and wherein sides of said cymbal are bisected by said grooves.

24. The cymbal according to claim 21, wherein a series of grooves of increasing depth progress outward from a center of said cymbal.

25. The cymbal according to claim 21, wherein said grooves are formed by compression of material comprising said cymbal.
